(19) United States
(12) Patent Application Publication
(10) Pub. No.: US 2022/0056331 A1
(43) Pub. Date: Feb. 24, 2022

(54) METHODS AND COMPOSITIONS FOR TREATMENT OF SCALE

(71) Applicant: KEMIRA OYJ, HELSINKI (FI)

(72) Inventor: Rick GRIFFIN, Kennesaw, GA (US)

(21) Appl. No.: 17/414,038

(22) PCT Filed: Dec. 30, 2019
(86) PCT No.: PCT/US2019/068958

§ 371 Date: Jun. 15, 2021

Related U.S. Application Data
(60) Provisional application No. 62/785,836, filed on Dec. 28, 2018.

(30) Foreign Application Priority Data
Mar. 27, 2019 (FI) 20195240

(51) Int. Cl. C09K 8/528

(52) U.S. Cl. CPC C09K 8/528; C09K 8/58

(57) ABSTRACT

The present embodiments generally relate to methods and compositions for the treatment of scale, such as controlling, preventing, and/or inhibiting sulfur-based scale formation and/or the rate of sulfur-based scale formation, in a fluid in need of treatment, such as fluids used in and/or resulting from oil and gas operations, wherein said treatment comprises the use of one or more scale modifiers. The one or more scale modifiers may comprise one or more polymer-based scale modifiers.

### CROSS-REFERENCE TO RELATED APPLICATIONS

This application claims the priority benefit of U.S. Provisional Application Ser. No. 62/785,836 (Atty. Docket No. 1149704.004200), filed Dec. 28, 2018, entitled “METHODS AND COMPOSITIONS FOR TREATMENT OF SCALE”, which is incorporated by reference herein in its entirety. This application further claims the priority benefit of Finnish Patent Application Ser. No. 20195240, filed Mar. 27, 2019, which is incorporated by reference herein in its entirety

### FIELD OF THE ART

The present disclosure generally relates to methods for controlling scale formation, wherein said methods comprise the use of one or more scale modifiers, such as one or more polymer-based scale modifiers; compositions comprising such one or more scale modifiers; and environments such as oil and gas wells and oilfield brines treated with such scale modifiers.

### BACKGROUND

Scale deposits may typically be formed by the precipitation and crystal growth of, e.g., solid salts, oxides, and hydroxides, at a surface in contact with a fluid, such as water or water vapor. In industrial fluids, such as produced waters in oil and gas extraction, and in process waters in mineral processing, alkaline earth metal or transition metals (cations) are generally present, including calcium, barium, and magnesium. In addition to cationic species, several anions are present as well, namely bicarbonate, carbonate, sulfate, phosphate, and silicate. Precipitation of these ions occurs when solubility is exceeded either in the bulk fluid or at the surfaces on which the scale forms, including pipes and autoclaves. Thermodynamically, crystallization or precipitation becomes feasible when the activity of ions in solution is above their saturation limit. The kinetics of precipitation can also be a key determinant of the severity of scaling, where nucleation of scale formation on surfaces induces the growth of crystals and low concentration of nucleation sites can slow the crystallization kinetics.

In industrial processing systems and circuits, scale formation can cause various problems. For example, in mineral processing systems, scale formation can cause reduced heat transfer efficiency, flow restrictions such as plugging of pipelines, under-deposit corrosion and microbiological growth resulting in reduced metal recovery, and increased cleaning costs and equipment damage and/or failure. These problems ultimately cause losses in production, increased operating costs and increased capital equipment expenditures. Scale formation can result in adverse effects, such as, for example, reduced production rates; flow restrictions which may include blockages and/or full plugging of pipelines, wellbores, and/or formations; under-deposit corrosion; increased water usage, and increased cleaning costs and equipment damage and/or failure in a number of industrial systems and circuits. These challenges ultimately cause losses in production, increased operating costs, and increased capital equipment expenditures.

In addition to scaling in aqueous solutions, scale formation can form in many processing fluids where high levels of dissolved solids are present, especially in such processes that also include heat transfer apparatus. These processes include, but are not limited to, processes that rely on autoclaves, and heat exchangers, such as carbon in leach circuits, carbon in pulp circuits, pressure oxidation equipment, flotation processes and thickener overflows. In cases where a heat transfer apparatus is used, such as heat exchangers or autoclaves, scale of a sufficient thickness reduces heat transfer efficiency. Such processes include, but are not limited to mining, mineral processing, oil and gas exploration and production, pulp, cardboard, and/or paper processing, and coal slurry transport.

As such, development of more efficient and cost-effective methods and compositions for scale treatment are therefore of great interest to a number of industries.

### BRIEF SUMMARY

The present disclosure generally relates to a method for reducing, inhibiting or stabilizing the formation of, or the amount of scale in a fluid, and/or reducing, inhibiting or stabilizing the deposition of scale on a surface in contact with said fluid, wherein said method comprises adding or introducing an amount of one or more scale modifiers to a fluid in need of treatment which is effective to reduce, inhibit or stabilize the formation or amount of scale in said fluid, and/or the deposition of scale on a surface in contact therewith wherein said one or more scale modifiers comprise one or more cationic polymers. In some embodiments, said one or more cationic polymers may comprise one or more diallyldimethylammonium chloride (DADMAC) monomers. In some embodiments, said scale may comprise one or more insoluble salts. In some embodiments, said one or more scale modifiers may comprise a polymer of one or more cationic monomers. In some embodiments, said one or more scale modifiers may comprise a homopolymer of cationic monomers. In some embodiments, said one or more scale modifiers may comprise a homopolymer of DADMAC. In some embodiments, said fluid in need of treatment may be in an environment and/or comprises constituents which may result in the formation of sulfur-based scale, e.g., said fluid comprises hydrogen sulfide and one or more metals. In some embodiments, said fluid in need of treatment may comprise sulfur-based scale. In some embodiments, said scale may be caused in whole or part by sulfate-reducing bacteria. In some embodiments, said scale may be caused in whole or part by hydrogen sulfide which results from the decomposition of sulfur containing minerals, e.g., iron, lead and/or zinc. In some embodiments, said scale may comprise any one or more of the following constituents: iron sulfide, zinc sulfide, lead sulfide, barium sulfate, strontium sulfate, and calcium sulfate. In some embodiments, said scale may comprise iron sulfide.

In some embodiments, said fluid in need of treatment may comprise a fluid resulting from any part of a process or processes related to oil or gas production, extraction, and/or recovery. In some embodiments, said fluid in need of treatment may comprise a circulating fluid. For instance, in some embodiments, said circulating fluid may comprise any one or more of the following: a circulating fluid utilized in, or a component of, a mining process, or in a system that is utilized in a mining process; a circulating fluid utilized in, or is a component of, a pulp, paper, and/or cardboard-related process, or is in a system that is utilized in a pulp, paper, and/or cardboard-related process; a circulating fluid utilized in, or a component of a reverse osmosis process; a circulating fluid utilized in, or a component of a geothermal application or method; a circulating fluid utilized in, or a component of, an oil and gas exploration or production process, or in a system that is utilized in an oil and gas exploration and production process; a circulating fluid utilized in, or a component of, coal processing, or in a system that is utilized in coal processing (e.g., coal slurry transport). In some embodiments, said fluid may comprise one used during processing of pulp, paper or cardboard. In some embodiments, said fluid in need of treatment may comprise produced water. In some embodiments, said fluid in need of treatment may comprise hydrogen sulfide and further may comprise one or more metals, e.g., iron, zinc, and/or lead, which may precipitate as a sulfur-based scale. In some embodiments, treatment of said fluid with said one or more scale modifiers may result in a 5% reduction or less, a 5% reduction or more, a 10% reduction or more, a 15% reduction or more, a 20% reduction or more, a 25% reduction or more, a 30% reduction or more, a 35% reduction or more, a 40% reduction or more, a 45% reduction or more, a 50% reduction or more, a 55% reduction or more, a 60% reduction or more, a 65% reduction or more, a 70% reduction or more, a 75% reduction or more, an 80% reduction or more, an 85% reduction or more, a 90% reduction or more, a 91% reduction or more, a 92% reduction or more, a 93% reduction or more, a 94% reduction or more, a 95% reduction or more, a 96% reduction or more, a 97% reduction or more, a 98% reduction or more, or a 99% reduction or more of scale formation, e.g., sulfur-based scale formation, such as sulfur-based scale is caused in whole or part by sulfate-reducing bacteria, e.g., sulfur-based scale formation which is caused in whole or part by hydrogen sulfide resulting from the decomposition of sulfur containing minerals, e.g., iron, lead and/or zinc sulfide scale formation, e.g., sulfur-based scale formation wherein said sulfur-based scale comprises any one or more of the following constituents: iron sulfide, zinc sulfide, lead sulfide, barium sulfate, strontium sulfate, and calcium sulfate, e.g., iron sulfide scale formation, as compared to a method which did not comprise the use of said one or more scale modifiers. In some embodiments, said method may further include the addition of at least one biocide, e.g., one that kills or inhibits the proliferation of sulfate-reducing bacteria. In some instances, the combined usage of said at least one biocide and said one or more scale modifiers which comprise one or more cationic polymers may have an additive or synergistic effect on the reduction, inhibition or stabilization of the formation of, or the amount of scale in the treated fluid, and/or on the reduction, inhibition or stabilization of the deposition of scale on a surface in contact with said fluid. In some embodiments, said at least one biocide may comprise at least one oxidizing biocide. In some embodiments, said oxidizing biocide may be any one or more of the following: an oxidant selected from chlorine, alkali and alkaline earth hypochlorite salts, hypochlorous acid, chlorinated isocyanurates, bromine, alkali and alkaline earth hypobromite salts, hypobromous acid, bromine chloride, chlorine dioxide, ozone, hydrogen peroxide, peroxy compounds, such as peracetic acid, performic acid, percarbonate or persulfate salts, halogenated hydantoins, e.g., monohalodimethylhydantoins such as monochlorodimethylhydantoin, or dihalodimethylhydantoins such as chlorobromodimethylhydantoin, monochloramines, monobromamines, dihaloamines, trihaloamines, or a combination thereof; optionally combined with substituted an N-hydrogen compound, such as ammonium salts, ammonia, urea, hydantoin, isothiazoline-1,1-dioxide, ethanolamine, pyrrolidone, 2-pyrrolidone, ethylene urea, N-methylolurea, N-methylurea, acetylurea, pyrrole, indole, formamide, benzamide, acetamide, imidazoline, or morpholine; and monochloramine (MCA), chlorine dioxide, performic acid (PFA), peracetic acid, alkali and alkaline earth hypochlorite salts, and N-hydrogen compounds combined with an oxidant. In some embodiments, said at least one biocide may comprise at least one non-oxidizing biocide. In some embodiments, said non-oxidizing biocide may be any one or more of the following: glutaraldehyde, 2,2-dibromo-3-nitrilopropionamide (DBNPA), 2-bromo-2-nitropropane-1,3-diol (Bronopol), quaternary ammonium compounds, carbamates, 5-chloro-2-methyl-4-isothiazolin-3-one (CM IT), 2-methyl-4-isothiazolin-3-one (MIT), 1,2-dibromo-2,4-dicyanobutane, bis(trichloromethyl)sulfone, 2-bromo-2-nitrostyrene, 4,5-dichloro-1,2-dithiol-3-one, 2-n-octyl-4-isothiazolin-3-one, 1,2-benzisothiazolin-3-one, ortho-phthaldehyde, quaternary ammonium compounds (=“quats”), such as n-alkyl dimethyl benzyl ammonium chloride, didecyl dimethyl ammonium chloride (DDAC) or alkenyl dimethylethyl ammonium chloride, guanidines, biguanidines, pyrithiones, 3-iodopropynyl-N-butylcarbamate, phosphonium salts, such as tetrakis hydroxymethyl phosphonium sulfate (THPS), dazomet, 2-(thiocyanomethylthio) benzothiazole, methylene bisthiocyanate (MBT), and a combination thereof.

In some embodiments, said method may comprise adding or introducing 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, or 500 ppm or more of said one or more scale modifiers. In some embodiments, said method may comprise adding or introducing an amount of said one or more scale modifiers which is an amount necessary to achieve a desired effect. In some embodiments, the molecular weight of said one or more scale modifiers may be from about 10,000 to about 2,000,000 Daltons, optionally from about 200,000 to about 400,000 Da. In some embodiments, said fluid may comprise a fluid used in an aqueous system. In some embodiments, said aqueous system may be boiler water, cooling water, seawater (e.g., in oil platform applications), brackish water, oilfield water (e.g., topside and/or downhole), coal processing water, or industrial treatment plant water. In some embodiments, said fluid in need of treatment may comprise oilfield water in need of treatment. In some embodiments, said oilfield water may comprise downhole water that is pumped underground (e.g., for enhanced oil recovery) and/or said oilfield water may comprise topside oilfield water. In some embodiments, said fluid in need of treatment may comprise any fluid resulting from any part of a process associated with enhanced oil recovery. In some embodiments, said fluid in need of treatment may comprise water that is used in and/or results from any part of a gas recovery process. In some embodiments, said fluid in need of treatment may comprise water that is used in and/or results from oil and/or gas recovery from a sour well. In some embodiments, said fluid in need of treatment may comprise water that is used in and/or results from any part of a process associated with a low cut gas well. In some embodiments, said fluid in need of treatment may comprise water that is used in and/or results from any part of a mining process. In some embodiments, said fluid in need of treatment may comprise water that is used in and/or results from any part of reverse osmosis. In some embodiments, said fluid in need of treatment may comprise water that is used in and/or results from any part of a geothermal process or application. In some embodiments, said one or more scale modifiers may be removed from treated process water after a desired period of time and/or a desired result has been achieved, such as by adding one or more oxidizing agents. In some embodiments, said method may further comprise further comprises the addition of one or more corrosion inhibitors, e.g., imidazolines, fatty amines, benzotriazole, quinoline, rosin amine, sodium phosphate, silicate, and chromate. In some embodiments, said fluid in need of treatment may comprise conditions suitable for the formation of sulfur-based scale, e.g., said fluid comprises hydrogen sulfide and one or more metals, and wherein said treatment does not generate any or does not generate as much hydrogen sulfide gas as compared to methods of treatment that do not comprise the use of one or more scale modifiers.

Moreover, the present disclosure generally relates to a composition suitable for use in the treatment of scale, wherein said composition comprises (i) an effective amount of one or more scale modifiers, wherein said one or more scale modifiers comprise one or more cationic polymers and (ii) optionally a fluid in need of treatment. In some embodiments, said composition may further comprise at least one biocide, e.g., one that kills or inhibits the proliferation of sulfate-reducing bacteria. In some embodiments, the combination of said at least one biocide and said one or more scale modifier which comprises one or more cationic polymers may have an additive or synergistic effect on the reduction, inhibition or stabilization of the formation of, or the amount of scale in a fluid susceptible to scale formation, and/or on the reduction, inhibition or stabilization of the deposition of scale on a surface in contact with a fluid susceptible to scale formation. In some embodiments, said at least one biocide may comprise at least one oxidizing biocide. In some embodiments, said oxidizing biocide may be any one or more of the following: an oxidant selected from chlorine, alkali and alkaline earth hypochlorite salts, hypochlorous acid, chlorinated isocyanurates, bromine, alkali and alkaline earth hypobromite salts, hypobromous acid, bromine chloride, chlorine dioxide, ozone, hydrogen peroxide, peroxy compounds, such as peracetic acid, performic acid, percarbonate or persulfate salts, halogenated hydantoins, e.g., monohalodimethylhydantoins such as monochlorodimethylhydantoin, or dihalodimethylhydantoins such as chlorobromodimethylhydantoin, monochloramines, monobromamines, dihaloamines, trihaloamines, or a combination thereof optionally combined with substituted an N-hydrogen compound, such as ammonium salts, ammonia, urea, hydantoin, isothiazoline-1,1-dioxide, ethanolamine, pyrrolidone, 2-pyrrolidone, ethylene urea, N-methylolurea, N-methylurea, acetylurea, pyrrole, indole, formamide, benzamide, acetamide, imidazoline, or morpholine; and monochloramine (MCA), chlorine dioxide, performic acid (PFA), peracetic acid, alkali and alkaline earth hypochlorite salts, and N-hydrogen compounds combined with an oxidant. In some embodiments, said at least one biocide may comprise at least one non-oxidizing biocide. In some embodiments, said non-oxidizing biocide may be any one or more of the following: glutaraldehyde, 2,2-dibromo-3-nitrilopropionamide (DBNPA), 2-bromo-2-nitropropane-1,3-diol (Bronopol), quaternary ammonium compounds, carbamates, 5-chloro-2-methyl-4-isothiazolin-3-one (CM IT), 2-methyl-4-isothiazolin-3-one (MIT), 1,2-dibromo-2,4-dicyanobutane, bis(trichloromethyl)sulfone, 2-bromo-2-nitrostyrene, 4,5-dichloro-1,2-dithiol-3-one, 2-n-octyl-4-isothiazolin-3-one, 1,2-benzisothiazolin-3-one, ortho-phthaldehyde, quaternary ammonium compounds (=“quats”), such as n-alkyl dimethyl benzyl ammonium chloride, didecyl dimethyl ammonium chloride (DDAC) or alkenyl dimethylethyl ammonium chloride, guanidines, biguanidines, pyrithiones, 3-iodopropynyl-N-butylcarbamate, phosphonium salts, such as tetrakis hydroxymethyl phosphonium sulfate (THPS), dazomet, 2-(thiocyanomethylthio) benzothiazole, methylene bisthiocyanate (MBT), and a combination thereof. In some embodiments, said one or more scale modifiers may comprise a homopolymer of cationic monomers. In some embodiments, said one or more scale modifiers may comprise a homopolymer of DADMAC. In some embodiments, said fluid may comprise a circulating fluid. In some embodiments, said fluid may comprise one used during processing of pulp, paper or cardboard. In some embodiments, said circulating fluid may comprise a circulating fluid utilized in, or is a component of, a mining process, or is in a system that is utilized in a mining process; a circulating fluid utilized in, or is a component of, a pulp, paper, and/or cardboard-related process, or is in a system that is utilized in a pulp, paper, and/or cardboard-related process; a circulating fluid utilized in, or a component of a reverse osmosis process; a circulating fluid utilized in, or a component of a geothermal application or method; a circulating fluid is utilized in, or is a component of, an oil and gas exploration or production process, or is in a system that is utilized in an oil and gas exploration and production process; or a circulating fluid is utilized in, or is a component of, coal processing, or is in a system that is utilized in coal processing (e.g., coal slurry transport). In some embodiments, said fluid may comprise fluid used in any process or part of a process involved in such process as, but not limited to, a mining process, or a system that is utilized in a mining process; a pulp, paper, and/or cardboard-related process, or a system that is utilized in a pulp, paper, and/or cardboard-related process; a reverse osmosis process, or a system that is utilized in reverse osmosis; a geothermal application or process, or a system that is utilized in a geothermal application or process; an oil and gas exploration or production process, or an oil and gas exploration and production process; or coal processing, or is in a system that is utilized in coal processing (e.g., coal slurry transport). In some embodiment, said fluid in need of treatment may comprise conditions suitable for the formation of sulfur-based scale, e.g., said fluid comprises hydrogen sulfide and one or more metals. In some embodiments, said fluid in need of treatment may comprise sulfur-based scale. In some embodiments, said fluid in need of treatment may comprise any one or more of the following: iron sulfide, zinc sulfide, or lead sulfide. In some embodiments, said fluid in need of treatment may comprise boiler water, cooling water, seawater (e.g., in oil platform applications), brackish water, oilfield water (e.g., topside and/or downhole), coal processing water, or industrial treatment plant water. In some embodiments, said fluid in need of treatment may comprise oilfield water in need of treatment. In some embodiments, said oilfield water may comprise downhole water that is pumped underground (e.g., for enhanced oil recovery). In some embodiments, said oilfield water may comprise topside oilfield water. In some embodiments, said fluid in need of treatment may comprise any fluid resulting from any part of a process associated with enhanced oil recovery. In some embodiments, said fluid in need of treatment may comprise any fluid resulting from any part of a process associated with processing of pulp, paper and/or cardboard. In some embodiments, said fluid in need of treatment may comprise produced water. In some embodiments, said fluid in need of treatment may comprise water that is used in and/or results from any part of a gas recovery process. In some embodiments, said fluid in need of treatment may comprise water that is used in and/or results from any part of reverse osmosis. In some embodiments, said fluid in need of treatment may comprise water that is used in and/or results from any part of a geothermal process or application. In some embodiments, said fluid in need of treatment may comprise a fluid associated with a sour well. In some embodiments, said fluid in need of treatment may comprise water that is used in and/or results from any part of a mining process. In some embodiments, said fluid in need of treatment may comprise a fluid used in conjunction with topside equipment. In some embodiments, said composition may further comprise one or more corrosion inhibitors, e.g., imidazolines, fatty amines, benzotriazole, quinoline, rosin amine, sodium phosphate, silicate, and chromate.

### BRIEF DESCRIPTION OF THE SEVERAL VIEWS OF THE DRAWING

FIG. 1 illustrates inhibition of scale formation from treatments comprising a dose of one of four different polymer-based scale inhibitors in accordance with Example 1.

FIG. 2 illustrates inhibition of scale formation from treatments comprising a dose of one of four different polymer-based scale inhibitors in accordance with Example 2.

### DETAILED DESCRIPTION

### Definitions

As used herein the singular forms “a”, “an”, and “the” include plural referents unless the context clearly dictates otherwise. All technical and scientific terms used herein have the same meaning as commonly understood to one of ordinary skill in the art to which this invention belongs unless clearly indicated otherwise.

As used herein, the term “enhanced oil recovery” or “EOR” (sometimes also known as improved oil recovery (“IOR”) or tertiary mineral oil production) generally refers to techniques for increasing the amount of unrefined petroleum (for example, crude oil) that may be extracted from an oil reservoir, such as an oil field. Examples of EOR techniques include, for example, miscible gas injection (e.g., carbon dioxide flooding), chemical injection, which is sometimes referred to as chemical enhanced oil recovery (“CEOR”), and which includes, for example, polymer flooding, alkaline flooding, surfactant flooding, micellar polymer flooding, conformance control operations, as well as combinations thereof such as alkaline-polymer flooding or alkaline-surfactant-polymer flooding, microbial injection, and thermal recovery (e.g., cyclic steam, steam flooding, or fire flooding). In some embodiments, the EOR operation may include a polymer (“P”) flooding operation, an alkaline-polymer (“AP”) flooding operation, a surfactant-polymer (“SP”) flooding operation, an alkaline-surfactant-polymer (“ASP”) flooding operation, a conformance control operation, or any combination thereof.

As used herein, the terms “polymer flood” or “polymer flooding” generally refer to a chemical enhanced EOR technique that typically involves injecting an aqueous fluid that is viscosified with one or more water-soluble polymers through injection boreholes into an oil reservoir to mobilize oil left behind after primary and/or secondary recovery. As a general result of the injection of one or more polymers, the oil may be forced in the direction of the production borehole, and the oil may be produced through the production borehole. Details of examples of polymer flooding and of polymers suitable for this purpose are disclosed, for example, in “Petroleum, Enhanced Oil Recovery, Kirk-Othmer, Encyclopedia of Chemical Technology, online edition, John Wiley & Sons, 2010”, which is herein incorporated by reference in its entirety. One or more surfactants may be injected (or formed in situ) as part of the EOR technique. Surfactants may function to reduce the interfacial tension between the oil and water, which may reduce capillary pressure and improve mobilization of oil. Surfactants may be injected with polymers (e.g., a surfactant-polymer (SP) flood), or formed in-situ (e.g., an alkaline-polymer (AP) flood), or a combination thereof (e.g., an alkaline-surfactant-polymer (ASP) flood). As used herein, the terms “polymer flood” and “polymer flooding” encompass all of these EOR techniques.

As used herein, the term “monomer” generally refers to nonionic monomers, anionic monomers, cationic monomers, zwitterionic monomers, betaine monomers, and amphoteric ion pair monomers.

As used herein, the terms “polymer,” “polymers,” “polymeric,” and similar terms are used in their ordinary sense as understood by one skilled in the art, and thus may be used herein to refer to or describe a large molecule (or group of such molecules) that may comprise recurring units. Polymers may be formed in various ways, including by polymerizing monomers and/or by chemically modifying one or more recurring units of a precursor polymer. Unless otherwise specified, a polymer may comprise a “homopolymer” that may comprise substantially identical recurring units that may be formed by, e.g., polymerizing, a particular monomer. Unless otherwise specified, a polymer may also comprise a “copolymer” that may comprise two or more different recurring units that may be formed by, e.g., copolymerizing, two or more different monomers, and/or by chemically modifying one or more recurring units of a precursor polymer. Unless otherwise specified, a polymer or copolymer may also comprise a “terpolymer” that may comprise polymers that may comprise three or more different recurring units. The term “polymer” as used herein is intended to include both the acid form of the polymer as well as its various salts. Polymers may be amphoteric in nature, i.e., containing both anionic and cationic substituents, although not necessarily in the same proportions.

As used herein the term “nonionic monomer” generally refers to a monomer that possesses a neutral charge. Nonionic monomers may comprise but are not limited to comprising monomers selected from the group consisting of acrylamide (“AMD”), acrylic, methacrylic, methacrylamido, vinyl, allyl, ethyl, and the like, all of which may be substituted with a side chain selected from, for example, an alkyl, arylalkyl, dialkyl, ethoxyl, and/or hydrophobic group. In some embodiments, a nonionic monomer may comprise AMD. In some embodiments, nonionic monomers may comprise but are not limited to comprising vinyl amide (e.g., acrylamide, methacrylamide, N-methylacrylamide, N,N-dimethylacrylamide), acryloylmorpholine, acrylate, maleic anhydride, N-vinylpyrrolidone, vinyl acetate, N-vinyl formamide and their derivatives, such as hydroxyethyl (methyl)acrylate CH2=CR—COO—CH2CH2OH (I) and CH2=CR—CO—N(Z1)(Z2) (2) N-substituted (methyl)acrylamide (II). R═H or Me; Z1=5-15C alkyl; 1-3C alkyl substituted by 1-3 phenyl, phenyl or 6-12C cycloalkyl (both optionally substituted) and Z2=H; or Z1 and Z2 are each 3-10C alkyl; (II) is N-tert. hexyl, tert. octyl, methylundecyl, cyclohexyl, benzyl, diphenylmethyl or triphenyl acrylamide. Nonionic monomers further may include dimethylaminoethylacrylate (“DMAEMA”), dimethylaminoethyl methacrylate (“DMAEM”), N-isopropylacrylamide and N-vinyl formamide. Nonionic monomers can be combined, for example to form a terpolymer of acrylamide, N-vinyl formamide, and acrylic acid.

As used herein, the term “anionic monomers” may refer to either anionic monomers that are substantially anionic in whole or (in equilibrium) in part, at a pH in the range of about 4.0 to about 9.0. The “anionic monomers” may be neutral at low pH (from a pH of about 2 to about 6), or to anionic monomers that are anionic at low pH.

Examples of anionic monomers which may be used herein which further may be substituted with other groups include but are not limited to those comprising acrylamide (“AMD”), acrylic, methacrylic, methacrylamido, vinyl, allyl, ethyl, and the like; maleic monomers and the like; calcium diacrylate; and/or any monomer substituted with a carboxylic acid group or salt thereof. In some embodiments, these anionic monomers may be substituted with a carboxylic acid group, and include, for example, acrylic acid, and methacrylic acid. In some embodiments, an anionic monomer which may be used herein may be a (meth)acrylamide monomer wherein the amide group has been hydrolyzed to a carboxyl group. Said monomer may be a derivative or salt of a monomer according to the embodiments. Additional examples of anionic monomers comprise but are not limited to those comprising sulfonic acids or a sulfonic acid group, or both. In some embodiments, the anionic monomers which may be used herein may comprise a sulfonic function that may comprise, for example, acrylamide tertiary butyl sulfonic acid (also known as 2-acrylamido-2-methylpropane sulfonic acid or N-t-butyl acrylamide sulfonic acid) (“ATBS”); vinylsulfonic acid; 4-styrenesulfonic acid; and/or any salts of any of these moieties/monomers. In some embodiments, anionic monomers may comprise organic acids. In some embodiments, anionic monomers may comprise acrylic acid, methacrylic acid, maleic acid, itaconic acid, acrylamido methylpropane sulfonic acid, vinylphosphonic acid, styrene sulfonic acid and their salts such as sodium, ammonium and potassium. Anionic monomers can be combined, for example, to form a terpolymer of acrylamide, acrylic acid and 2-acrylamido-2-methylpropane sulfonic acid.

As used herein, the term “cationic monomer” generally refers to a monomer that possesses a positive charge. Examples of cationic monomers may comprise but are not limited to those comprising acryloyloxy ethyl trimethyl ammonium chloride (“AETAC”), methacryloyloxyethyltrimethylammonium chloride, methacrylamidopropyltrimethylammonium chloride (“MAPTAC”), acrylamidopropyltrimethylammonium chloride, methacryloyloxyethyldimethylammonium sulfate, dimethylaminoethyl acrylate, dimethylaminopropylmethacrylamide, Q6, Q6o4, and/or diallyldimethylammonium chloride (“DADMAC”).

Said cationic monomers may also comprise but are not limited to comprising dialkylaminoalkyl acrylates and methacrylates and their quaternary or acid salts, including, but not limited to, dimethylaminoethyl acrylate methyl chloride quaternary salt (“DMAEA.MCQ”), dimethylaminoethyl acrylate methyl sulfate quaternary salt (“DMAEM.MCQ”), dimethyaminoethyl acrylate benzyl chloride quaternary salt (“DMAEA.BCQ”), dimethylaminoethyl acrylate sulfuric acid salt, dimethylaminoethyl acrylate hydrochloric acid salt, diethylaminoethyl acrylate, methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt, dialkylaminoalkylacrylamides or methacrylamides and their quaternary or acid salts such as acrylamidopropyltrimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate and diallyldialkylammonium halides such as diallyldiethylammonium chloride and diallyldimethyl ammonium chloride. Alkyl groups may generally but are not limited to those comprising C₁₋₈ alkyl groups. In some embodiments, cationic monomers may comprise quaternary ammonium or acid salts of vinyl amide, vinyl carboxylic acid, methacrylate and their derivatives. Cationic monomers may comprise but are not limited to comprising monomers selected from the group consisting of dimethylaminoethylacrylate methyl chloride quaternary salt, dimethylaminoethylmethacrylate methyl chloride quaternary salt, and diallyldimethyl ammonium chloride. Cationic monomers can be combined, for example, to form a terpolymer of dimethylaminoethylmethacrylate methyl chloride quaternary salt, and diallyldimethyl ammonium chloride and acrylamide.

The term “water-soluble polymer” generally refers to any polymer that may dissolve, disperse, or swell in water. Said polymers may modify the physical properties of aqueous systems undergoing gellation, thickening, viscosification, or emulsification/stabilization. Said polymers may perform a variety of functions, including but not limited to use as dispersing and suspending agents, stabilizers, thickeners (“thickening polymer” and/or “thickening agent”), viscosifiers (“viscosifying polymer” and/or “viscosifying agent”), gellants, flocculants and coagulants, film-formers, humectants, binders, and lubricants.

As used herein, the terms “polyacrylamide” or “PAM” generally refer to polymers and co-polymers comprising acrylamide moieties, and the terms encompass any polymers or copolymers comprising acrylamide moieties, e.g., one or more acrylamide (co)polymers. Furthermore, PAMs may comprise any of the polymers or copolymers discussed herein. In some embodiments, PAMS may comprise sulfonated PAM, such as, for example, copolymers of acrylamide and acrylamide tertiary butyl sulfonic acid (also known as 2-acrylamido-2-methylpropane sulfonic acid or N-t-butyl acrylamide sulfonic acid) (“ATBS”); vinylsulfonic acid; 4-styrenesulfonic acid; and/or any salts of any of these moieties/monomers. Additionally, the PAMs described herein, e.g., one or more acrylamide (co)polymers, may be provided in one of various forms, including, for example, dry (powder) form (e.g., DPAM), water-in-oil emulsion (inverse emulsion), suspension, dispersion, or partly hydrolyzed (e.g., HPAM, in which some of the acrylamide units have been hydrolyzed to acrylic acid). In some embodiments, PAMs, e.g., one or more acrylamide (co)polymers, may be used for polymer flooding. In some embodiments, PAMS, e.g., one or more acrylamide (co)polymers, may be used in any EOR technique.

As used herein, the term “produced water” generally refers to any aqueous fluids produced during any type of industrial process, e.g., an oil or gas extraction or recovery process, e.g., a mining process, e.g., a pulp, paper, or cardboard process, e.g., a coal transport process, or any portion thereof, such as but not limited to any enhanced oil recovery process or any portion thereof. Typically the produced water may be obtained during an industrial process involving the use of water, and, in some instances, the use of one or more water soluble polymers.

According to some embodiments, the produced water may be formed during any part of a process related to polymer flooding and may comprise any components and/or chemicals related to any part of said polymer flooding. This may be referred to as “polymer flooded produced water” or “polymer flooding produced water”, and the term produced water is to be understood to encompass any type of polymer flooded produced water or polymer flooding produced water.

As used herein, the terms “scale” and “mineral scale” generally refer to the accumulation of unwanted material on solid surfaces, and particularly includes environments wherein such deposition is to the detriment of the functioning, stability and/or physical integrity of the solid surface comprising such deposition such as an apparatus on which scale forms. In some instances, such unwanted material may include insoluble substances such as insoluble salts, that have a tendency to form in aqueous systems, such as boiler water, cooling water, seawater (e.g., in oil platform applications), brackish water, oilfield water, municipal treatment plant water, paper mill water (such as water used to process pulp, paper, and/or cardboard), mining water, water resulting from any part of a method associated with enhanced oil recovery, water resulting from gas recovery, water resulting from oil recovery, and industrial treatment plant water. In some instances, scale may be a sulfur-based scale.

As used herein, the term “sulfur-based scale” generally refers to any scale that comprises sulfur. For example, sulfur-based scale may include, but is not limited to including, iron sulfide, zinc sulfide, lead sulfide, barium sulfate, strontium sulfate, and calcium sulfate, for example. In some instances, sulfur-based scale may form and/or be present in aqueous systems, such as boiler water, cooling water, seawater (e.g., in oil platform applications), brackish water, oilfield water, gasfield water, municipal treatment plant water, paper mill water (such as water used to process pulp, paper, and/or cardboard), mining water, reverse osmosis process water, water used in geothermal applications, water resulting from any part of a method associated with enhanced oil recovery, water resulting from gas recovery, water resulting from oil recovery, and industrial treatment plant water. In some instances, sulfur-based scale may be present that may occur processes and apparatuses used in the oil and gas industry, such as, for example, when production occurs in sour wells that contain hydrogen sulfide. The presence of hydrogen sulfide in wells may be a result of the presence of bacteria such as sulfate-reducing bacteria, or from naturally occurring hydrogen sulfide formed from the decomposition of sulfur containing minerals, for example. In some instances, sulfur-based scale may form when hydrogen sulfide comes into contact with metal cations, such as, for example, iron, lead and/or zinc, which may lead to sulfide mineral scale formation. In some instances, the formation of sulfur-based scale may interfere with the separation of water and oil in topside equipment by forming an emulsified oil and water layer in the topside separation equipment. In some instances, sulfur-based scale may be present in the oil phase, which may be problematic for methods and processes involving the use of separators.

As used herein, the terms “scale modifier”, “anti-scale agent”, and the like, generally refer to chemical compounds, e.g., polymers, or compositions containing such compounds, that may be added to a fluid, to interfere with nucleation, growth, and/or agglomeration of particles that may form scale, such as sulfur-based scale, and thereby control, reduce, inhibit, or prevent the formation, deposition, and/or adherence of scale deposits on substrate surfaces in contact with scale-forming fluids. The scale modifiers may control, reduce, inhibit, or prevent the formation of scale (for example, the total amount and/or rate of formation of scale such as sulfur-based scales) in a particular system as compared to an equivalent system that does not contain the added scale modifier. In some embodiments, a scale modifier is added to a fluid in which scale may form, such as, for example, a fluid comprising the components that form sulfur-based scale, e.g., hydrogen sulfide and a metal, which may be referred to as a fluid in need of treatment. In some embodiments, a scale modifier may comprise a polymer-based scale modifier, i.e., a scale modifier comprising one or more polymers. In some embodiments, a scale modifier may comprise a polymer of cationic monomers. In some embodiments, a scale modifier may comprise a homopolymer of cationic monomers. In some embodiments, a scale modifier may comprise a homopolymer of diallyldimethylammonium chloride (DADMAC). In some embodiments, a scale modifier may consist essentially of a homopolymer of DADMAC. In some embodiments, a scale modifier may comprise a copolymer comprising DADMAC. In some embodiments, a scale modifier may comprise one or more DADMAC monomers, and may have a molecular weight from about 10,000 to about 2,000,000 Daltons, optionally from about 200,000 to about 400,000 Da.

As used herein, the terms “treatment of scale”, “treating scale”, “preventing scale”, “controlling scale”, and “inhibiting scale”, the like, generally refer to using scale modifiers and/or compositions comprising scale modifiers, such as those described herein, to treat, reduce, control, prevent, and/or inhibit the amount of scale formed and/or treat, reduce, control, prevent, and/or inhibit the rate of formation of scale in various industrial processes and systems in which scale may form as compared to in equivalent processes that do not contain the scale modifiers and/or compositions comprising. In some instances, the scale to be treated or prevented, etc., may be a sulfur-based scale.

As used herein, the term “fluid in need of treatment” generally refers to any fluid which may comprise scale and/or in which scale may form, such as sulfur-based scale and/or in which sulfur-based scale may form and/or in which sulfur and a metal may precipitate as a sulfur-based scale. In some embodiments, a fluid in need of treatment may comprise produced water. In some embodiments, a fluid in need of treatment may comprise water related to gas production and/or gas exploration processes. In some embodiments, a fluid in need of treatment may comprise sea water or other brackish water. In some instances, a fluid in need of treatment may comprise boiler water, cooling water, seawater (e.g., in oil platform applications), brackish water, oilfield water, municipal treatment plant water, paper mill water (such as water used to process pulp, paper, and/or cardboard), mining water, water resulting from any part of a method associated with enhanced oil recovery, reverse osmosis process water, water used in geothermal applications or methods, water resulting from gas recovery, water resulting from oil recovery, and/or industrial treatment plant water. In some instances, a fluid in need of treatment may comprise a circulating fluid. In some embodiments, the circulating fluid is utilized in, or is a component of, a mining process, or is in a system that is utilized in a mining process. In some embodiments, the circulating fluid is utilized in, or is a component of, a pulp, paper, and/or cardboard-related process, or is in a system that is utilized in the processing of pulp, paper, and/or cardboard. In some embodiments, the circulating fluid is utilized in, or is a component of, an oil and gas exploration or production process, or is in a system that is utilized in an oil and gas exploration and production process. In some embodiments, the circulating fluid is utilized in, or is a component of, coal processing, or is in a system that is utilized in coal processing (e.g., coal slurry transport). In some embodiments, the circulating fluid is utilized in, or is a component of a reverse osmosis process. In some embodiments, the circulating fluid is utilized in, or is a component of a geothermal application or method.

### METHODS AND COMPOSITIONS

Disclosed herein are methods and compositions for the treatment or prevention of scale, such as sulfur-based scale resulting from any process related to oil or gas production, extraction, and/or recovery; as well as any industrial process in which scale formation, e.g., sulfur-based scale formation, is problematic to said process or to the functioning, stability, and/or physical integrity of materials such as apparatus used in such processes. Further disclosed herein are environments such as oil and gas wells and other environments wherein scale formation, e.g., sulfur-based scale formation, is problematic which are treated with an amount of one or more scale-modifiers effective to reduce scale formation or deposition. In some embodiments, a method for treating or preventing scale may comprise treatment with one or more scale modifiers. In some embodiments, a method for treating or preventing scale may comprise treatment with one or more polymer-based scale modifiers. In some embodiments, a method for treating or preventing scale may comprise treatment with a polymer comprising one or more cationic monomers. In some embodiments, a method for treating or preventing scale may comprise treatment with a polymer comprising a homopolymer of cationic monomers. a method for treating or preventing scale may comprise treatment with a polymer comprising a homopolymer of DADMAC. In some embodiments, a method for reducing, inhibiting or stabilizing the formation of, or the amount of scale in a fluid, and/or reducing, inhibiting or stabilizing the deposition of scale on a surface in contact with said fluid may comprise adding or introducing an amount of one or more scale modifiers to a fluid in need of treatment which is effective to reduce, inhibit or stabilize the formation or amount of scale in said fluid, and/or the deposition of scale on a surface in contact therewith, wherein said one or more scale modifiers comprise one or more cationic polymers, e.g., one or more homopolymers of DADMAC, e.g., one or more copolymers comprising DADMAC.

In some embodiments, methods of treating scale, e.g., sulfur-based scale, with one or more scale modifiers may prevent, inhibit, reduce, and/or stabilize formation of sulfur-based scale, e.g., iron sulfide scale and/or zinc sulfide scale and/or lead sulfide scale, in a fluid of need of treatment and/or prevent, inhibit, reduce or stabilize deposition of said scale, wherein said scale may have resulted from an oil or gas production or recovery process. In some embodiments, methods of treating scale with one or more scale modifiers, e.g., one or more polymer-based scale modifiers, may result in a 5% reduction or less, a 5% reduction or more, a 10% reduction or more, a 15% reduction or more, a 20% reduction or more, a 25% reduction or more, a 30% reduction or more, a 35% reduction or more, a 40% reduction or more, a 45% reduction or more, a 50% reduction or more, a 55% reduction or more, a 60% reduction or more, a 65% reduction or more, a 70% reduction or more, a 75% reduction or more, an 80% reduction or more, an 85% reduction or more, a 90% reduction or more, a 91% reduction or more, a 92% reduction or more, a 93% reduction or more, a 94% reduction or more, a 95% reduction or more, a 96% reduction or more, a 97% reduction or more, a 98% reduction or more, or a 99% reduction or more of scale formation, e.g., sulfur-based scale formation, e.g., iron sulfide scale, as compared to a method which did not comprise treatment with said one or more scale modifiers.

In some embodiments, methods of treating or preventing scale with one or more scale modifiers, e.g., one or more polymer-based scale modifiers comprising a homopolymer of cationic monomers, may comprise adding 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, or 500 ppm or more of said one or more scale modifiers.

In some embodiments, one or more scale modifiers for use in the treatment or preventing of scale may be provided in liquid form, e.g., as an aqueous solution. In some embodiments, one or more scale modifiers for use in the treatment of scale may be water-soluble. In some embodiments, one or more scale modifiers for use in the treatment of scale may be provided in dry form and/or powder form. In some embodiments, methods of treating scale with one or more scale modifiers may comprise treatment with one or more scale modifiers, e.g., a homopolymer of DADMAC, whose molecular weight may be from about 10,000 to about 2,000,000 Daltons, optionally from about 200,000 to about 400,000 Da.

In some embodiments, addition and/or introduction of one or more scale modifiers in a method for treatment or prevention of scale may be a continuous application or a direct, e.g., intermittent injection of said one or more scale modifiers into the process and/or component in need of treatment, e.g., continuous or direct injection into a formation in need of treatment. Said application and/or injection may be accomplished using any techniques known and used in the art, especially methods used in oil and gas recovery and treatment of oil and gas deposits and desalination methods. In some embodiments, addition and/or introduction of said one or more scale modifiers may be intermittent addition to the fluid as necessary or desired. In some embodiments, the amount of one or more scale modifiers used to treat scale may be any amount that results in a desired effect, i.e., any desired degree of reduction of scale formation or reduction in the rate of scale formation inhibition, reduction, prevention, and/or control that is desired for a given process.

In some embodiments, methods of treating or preventing scale with one or more scale modifiers may occur at any temperature at which a process in need of treatment of scale occurs. For example, the temperature may be atmospheric temperature. In some instances, the temperature may be 30° C. or less, 30° C. or more, 35° C. or more, 40° C. or more, 45° C. or more, 50° C. or more, 55° C. or more, 60° C. or more, 65° C. or more, 70° C. or more, 75° C. or more, 80° C. or more, 85° C. or more, 90° C. or more, 95° C. or more, 100° C. or more, 125° C. or more, or 150° C. or more. In some embodiments, a scale modifier, such as a polymer-based scale modifier comprising a homopolymer of DADMAC, that is thermally treated may demonstrate a similar performance or the same performance or better performance as the same scale modifier that has not be thermally treated. For example, a thermal treatment may be treatment of said scale modifier at an elevated temperature for a duration of time, such as, for example, treatment at 150° C. or less or 150° C. or more for 3 days or less or 3 days or more. In some embodiments, a scale modifier may comprise a homopolymer of DADMAC, and said homopolymer of DADMAC may be more thermally stable as compared to other polymeric dispersants, such as polyacrylamide, when used in methods of treating scale, e.g., scale comprising iron sulfide.

In some embodiments, methods of treating or preventing scale with one or more scale modifiers may occur at any pH at which a process in need of treatment of scale occurs. In some embodiments, one or more scale modifiers may be removed from treated process water after a desired period of time and/or a desired result has been achieved, such as by adding one or more oxidizing agents. The one or more scale modifiers described herein may be used in methods for the treatment or prevention of scale, e.g., iron sulfide and/or lead sulfide and/or zinc sulfide, in aqueous systems. In some embodiments, a method for treating scale, may comprise adding one or more scale modifiers as described herein to an aqueous system in need of scale treatment, in an amount effective to reduce or inhibit scale, e.g., iron sulfide and/or lead sulfide and/or zinc sulfide, in the aqueous system. Methods for identifying aqueous systems in need of scale treatment are known to those skilled in the art.

A broad variety of aqueous systems may be treated to reduce scale, e.g., sulfur-based scale, using the methods described herein. Non-limiting examples of such aqueous systems include boiler water, cooling water, produced water, seawater (e.g., in oil platform applications), brackish water, oilfield water (e.g., topside and/or downhole), coal processing water, and industrial treatment plant water. The amount of one or more scale modifiers that is effective to reduce or inhibit scale in a particular aqueous system may be determined by routine experimentation in light of the guidance provided herein. In some embodiments, a method for treating or preventing scale may comprise adding one or more scale modifiers to oilfield water in need of scale treatment, in an amount effective to reduce or inhibit scale, e.g., sulfur-based scale, e.g., iron sulfide and/or lead sulfide and/or zinc sulfide, in the oilfield water. For example, the scale modifier may be added to process water (produced water) on an oil platform. The oilfield water may be downhole water that is pumped underground (e.g., for enhanced oil recovery) and/or may be used to treat topside oilfield water. In some embodiments, methods of treating scale with one or more scale modifiers may comprise treatment of water that is used in and/or results from any part of an enhanced oil recovery process. In some embodiments, methods of treating or preventing scale with one or more scale modifiers may comprise treatment of water that is used in and/or results from any part of a gas recovery or production process. In some embodiments, methods of treating or preventing scale with one or more scale modifiers may comprise treatment of water that is used in and/or results from any part of a mining process. In some embodiments, methods of treating or preventing scale with one or more scale modifiers may comprise treatment of water that is used in and/or results from any part of the processing of pulp, paper, and/or cardboard. In some embodiments, methods of treating or preventing scale with one or more scale modifiers may comprise treatment of produced water. In some embodiments, methods of treating or preventing scale with one or more scale modifiers may comprise treating a formation in which scale may form. In some embodiments, methods of treating or preventing scale with one or more scale modifiers may comprise treatment of a fluid in need of treatment, such as any fluid in which scale, e.g., sulfur-based scale, may form, particularly wherein scale formation is problematic for a process in which the fluid in need of treatment may be used or may be a part of. In some embodiments, methods of treating or preventing scale with one or more scale modifiers may comprise treatment of a fluid in need of treatment, wherein said fluid in need of treatment comprises sulfur-based scale, e.g., iron sulfate and/or zinc sulfide and/or lead sulfide. In some embodiments, a method for treating or preventing scale may comprise adding one or more scale modifiers and one or more corrosion inhibitors to a fluid in need of treatment. Examples of corrosion inhibitors include, but are not limited to, imidazolines, fatty amines, benzotriazole, quinoline, rosin amine, sodium phosphate, silicate, and chromate.

In some embodiments, a method for treating or preventing scale may comprise adding one or more scale modifiers to fluid in need of treatment that may be used in conjunction with topside equipment that may be used in gas and/or oil recovery, such as equipment for separation of water and oil. For example, in such topside equipment, formation of scale, e.g., sulfur-based scale, may interfere with the separation of water and oil in said equipment as said scale may promote formation of an emulsified oil and water layer in said equipment. Treatment of such topside equipment with one or more scale modifiers, e.g., one or more scale modifiers comprising a homopolymer of DADMAC, may treat such scale, such as by preventing formation of the scale and/or preventing deposition of the scale onto said equipment by a dispersion mechanism, thereby increasing the efficiency of the oil water separation of the topside equipment. Furthermore, in such instances, said treatment may result in the dispersed sulfur-based scale remaining in the water phase of the topside separation equipment and may prevent the emulsion layer between oil and water from forming.

Not wishing to be bound by theory, however the inventors theorize that in the subject methods for treating or preventing scale by the addition of one or more scale modifiers to a fluid in need of treatment may prevent or inhibit or treat scale as a consequence of said one or more scale modifiers absorbing to the surface of scale as it is forming, thereby modifying the surface charge of said forming scale and/or slowing or preventing scale formation, i.e., by creating a positively charged surface that may disfavor scale formation. This modification of surface charge may also aid in dispersion of the scale before it can form by creating repulsion between the scale particles.

In some instances, after brine comes to saturation, scale, such as sulfur based-scale, may begin to form and plug production lines, filters, pumps, and/or screens, for example, and treatment with one or more scale modifiers may reduce the occurrence or severity of, prevent, and/or eliminate such events from occurring. Furthermore, methods of treating or preventing scale with one or more scale modifiers may be used in conjunction with any process that may involve formation of brine in which scale, e.g., sulfur-based scale, may form and may plug production lines, filters, pumps, and/or screens. In some embodiments, methods of treating or preventing scale with one or more scale modifiers may prevent and/or reduce plugging of a fluid conduit disposed in an injection wellbore. In some embodiments, methods of treating or preventing scale with one or more scale modifiers may prevent and/or reduce plugging of a subterranean formation. In some embodiments, methods of treating or preventing scale with one or more scale modifiers may prevent and/or reduce plugging of a production well and/or components associated with a production well.

In some embodiments, methods of treating or preventing scale, e.g., sulfur-based scale, with one or more scale modifiers may be used in conjunction with treatment of scales that may occur in oil and/or gas recovery when production may occur in a sour well, e.g., a well which contains hydrogen sulfide. For example, in sour wells, hydrogen sulfide may occur due to the presence of sulfate-reducing bacteria, and/or may occur due to naturally occurring hydrogen sulfide that forms from the decomposition of sulfur containing minerals. When hydrogen sulfide is present, it may form a sulfur-based mineral scale when it comes into contact with metal cations, such as, for example, iron, lead, or zinc. Treatment of such sour wells with one or more scale modifiers, e.g., one or more homopolymers of DADMAC, may treat, reduce, control, prevent, and/or inhibit the amount of scale formed in such a well. In some embodiments, a method for treating or preventing scale may comprise adding one or more scale modifiers to fluid in need of treatment, wherein said fluid in need of treatment comprises sulfur-based scale, and wherein said treatment does not generate any or does not generate as much hydrogen sulfide gas as compared to methods of treatment that do not comprise the use of one or more scale modifiers such as those discussed herein, e.g., one or more scale modifiers comprising a homopolymer of cationic monomers and/or one or more scale modifiers comprising a homopolymer of DADMAC.

In some embodiments, scale to be treated with the methods and compositions disclosed herein may comprise scale that is caused in whole or in part by bacteria such as sulfate-reducing bacteria. In some embodiments, scale to be treated with the methods and compositions disclosed herein may comprise scale that is caused in whole or part by hydrogen sulfide which results from the decomposition of sulfur containing minerals, e.g., iron, lead and/or zinc. In some embodiments, scale to be treated with the methods and compositions disclosed herein may comprise sulfur-based scale, further wherein said sulfur-based scale may be caused in whole or in part by sulfate-reducing bacteria. In some embodiments, scale to be treated with the methods and compositions disclosed herein may comprise sulfur-based scale, further wherein said sulfur-based scale may be caused in whole or part by hydrogen sulfide resulting from the decomposition of sulfur containing minerals, e.g., iron, lead and/or zinc. In some embodiments, a method of treating scale, such as sulfur-based scale, may comprise addition of one or more scale modifiers and one or more biocides, e.g., one that kills or inhibits the proliferation of sulfate-reducing bacteria. Such biocides may include, but are not limited to including, oxidizing and/or non-oxidizing biocides. Furthermore, oxidizing biocides may include, but are not limited to including an oxidant selected from chlorine, alkali and alkaline earth hypochlorite salts, hypochlorous acid, chlorinated isocyanurates, bromine, alkali and alkaline earth hypobromite salts, hypobromous acid, bromine chloride, chlorine dioxide, ozone, hydrogen peroxide, peroxy compounds, such as peracetic acid, performic acid, percarbonate or persulfate salts, halogenated hydantoins, e.g., monohalodimethylhydantoins such as monochlorodimethylhydantoin, or dihalodimethylhydantoins such as chlorobromodimethylhydantoin, monochloramines, monobromamines, dihaloamines, trihaloamines, or a combination thereof. In some instances, the oxidant can be combined with an optionally substituted N-hydrogen compound. Particular N-hydrogen compounds are selected from ammonium salts, ammonia, urea, hydantoin, isothiazoline-1,1-dioxide, ethanolamine, pyrrolidone, 2-pyrrolidone, ethylene urea, N-methylolurea, N-methylurea, acetylurea, pyrrole, indole, formamide, benzamide, acetamide, imidazoline, or morpholine. Other suitable N-hydrogen compounds are disclosed in WO 2012/101051 A1. Particularly suitable oxidizing biocides can include ammonium salts reacted with an oxidant, for example, ammonium bromide or ammonium sulfate, or any other ammonium salt, which is reacted with an oxidant, e.g., hypochlorite, or urea reacted with an oxidant, e.g., hypochlorite. Further oxidizing biocides can be selected from monochloramine (MCA), chlorine dioxide, performic acid (PFA), peracetic acid, alkali and alkaline earth hypochlorite salts, and N-hydrogen compounds combined with an oxidant. Non-oxidizing biocides may include, but are not limited to including glutaraldehyde, 2,2-dibromo-3-nitrilopropionamide (DBNPA), 2-bromo-2-nitropropane-1,3-diol (Bronopol), quaternary ammonium compounds, carbamates, 5-chloro-2-methyl-4-isothiazolin-3-one (CM IT), 2-methyl-4-isothiazolin-3-one (MIT), 1,2-dibromo-2,4-dicyanobutane, bis(trichloromethyl)sulfone, 2-bromo-2-nitrostyrene, 4,5-dichloro-1,2-dithiol-3-one, 2-n-octyl-4-isothiazolin-3-one, 1,2-benzisothiazolin-3-one, ortho-phthaldehyde, quaternary ammonium compounds (=“quats”), such as n-alkyl dimethyl benzyl ammonium chloride, didecyl dimethyl ammonium chloride (DDAC) or alkenyl dimethylethyl ammonium chloride, guanidines, biguanidines, pyrithiones, 3-iodopropynyl-N-butylcarbamate, phosphonium salts, such as tetrakis hydroxymethyl phosphonium sulfate (THPS), dazomet, 2-(thiocyanomethylthio) benzothiazole, methylene bisthiocyanate (MBT), and a combination thereof. In some embodiments, the combined usage of said at least one biocide and one or more scale modifiers which comprise one or more cationic polymers may have an additive or synergistic effect on the reduction, inhibition or stabilization of the formation of, or the amount of scale in the treated fluid, and/or on the reduction, inhibition or stabilization of the deposition of scale on a surface in contact with said fluid.

Furthermore, in some embodiments, methods of treating or preventing scale with one or more scale modifiers may comprise addition of said one or more scale modifiers to a circulating fluid. In some embodiments, the circulating fluid is utilized in, or is a component of, a mining process, or is in a system that is utilized in a mining process. In some embodiments, the circulating fluid is utilized in, or is a component of, a pulp, paper, and/or cardboard-related process, or is in a system that is utilized in the processing of pulp, paper, and/or cardboard. In some embodiments, the circulating fluid is utilized in, or is a component of, an oil and gas exploration or production process, or is in a system that is utilized in an oil and gas exploration and production process. In some embodiments, the circulating fluid is utilized in, or is a component of, coal processing, or is in a system that is utilized in coal processing (e.g., coal slurry transport).

Moreover, the present disclosure generally relates to a composition suitable for use in the treatment of scale, e.g., sulfur-based scale, comprising one or more scale modifiers and a fluid in need of treatment, i.e., a fluid in which scale may form, such as, for example, produced water resulting from any of the industrial processes described herein or known in the art. In some embodiments, a composition suitable for use in the treatment of scale may comprise a polymer of cationic monomers. In some embodiments, a composition suitable for use in the treatment of scale may comprise a homopolymer of cationic monomers. In some embodiments, a composition suitable for use in the treatment of scale may comprise a homopolymer of DADMAC. In some embodiments, a composition suitable for use in the treatment of scale may comprise (i) an effective amount of one or more scale modifiers, wherein said one or more scale modifiers comprise one or more cationic polymers and (ii) optionally a fluid in need of treatment.

In some embodiments, said composition may further comprise at least one biocide, e.g., one that kills or inhibits the proliferation of sulfate-reducing bacteria. Such biocides may include, but are not limited to including, oxidizing and/or non-oxidizing biocides. Furthermore, oxidizing biocides may include, but are not limited to including an oxidant selected from chlorine, alkali and alkaline earth hypochlorite salts, hypochlorous acid, chlorinated isocyanurates, bromine, alkali and alkaline earth hypobromite salts, hypobromous acid, bromine chloride, chlorine dioxide, ozone, hydrogen peroxide, peroxy compounds, such as peracetic acid, performic acid, percarbonate or persulfate salts, halogenated hydantoins, e.g., monohalodimethylhydantoins such as monochlorodimethylhydantoin, or dihalodimethylhydantoins such as chlorobromodimethylhydantoin, monochloramines, monobromamines, dihaloamines, trihaloamines, or a combination thereof. In some instances, the oxidant can be combined with an optionally substituted N-hydrogen compound. Particular N-hydrogen compounds are selected from ammonium salts, ammonia, urea, hydantoin, isothiazoline-1,1-dioxide, ethanolamine, pyrrolidone, 2-pyrrolidone, ethylene urea, N-methylolurea, N-methylurea, acetylurea, pyrrole, indole, formamide, benzamide, acetamide, imidazoline, or morpholine. Other suitable N-hydrogen compounds are disclosed in WO 2012/101051 A1. Particularly suitable oxidizing biocides can include ammonium salts reacted with an oxidant, for example, ammonium bromide or ammonium sulfate, or any other ammonium salt, which is reacted with an oxidant, e.g., hypochlorite, or urea reacted with an oxidant, e.g., hypochlorite. Further oxidizing biocides can be selected from monochloramine (MCA), chlorine dioxide, performic acid (PFA), peracetic acid, alkali and alkaline earth hypochlorite salts, and N-hydrogen compounds combined with an oxidant. Non-oxidizing biocides may include, but are not limited to including glutaraldehyde, 2,2-dibromo-3-nitrilopropionamide (DBNPA), 2-bromo-2-nitropropane-1,3-diol (Bronopol), quaternary ammonium compounds, carbamates, 5-chloro-2-methyl-4-isothiazolin-3-one (CM IT), 2-methyl-4-isothiazolin-3-one (MIT), 1,2-dibromo-2,4-dicyanobutane, bis(trichloromethyl)sulfone, 2-bromo-2-nitrostyrene, 4,5-dichloro-1,2-dithiol-3-one, 2-n-octyl-4-isothiazolin-3-one, 1,2-benzisothiazolin-3-one, ortho-phthaldehyde, quaternary ammonium compounds (=“quats”), such as n-alkyl dimethyl benzyl ammonium chloride, didecyl dimethyl ammonium chloride (DDAC) or alkenyl dimethylethyl ammonium chloride, guanidines, biguanidines, pyrithiones, 3-iodopropynyl-N-butylcarbamate, phosphonium salts, such as tetrakis hydroxymethyl phosphonium sulfate (THPS), dazomet, 2-(thiocyanomethylthio) benzothiazole, methylene bisthiocyanate (MBT), and a combination thereof. In some embodiments, a composition comprising at least one biocide and one or more scale modifiers which comprise one or more cationic polymers may have an additive or synergistic effect on the reduction, inhibition or stabilization of the formation of, or the amount of scale in a fluid susceptible to scale formation, and/or on the reduction, inhibition or stabilization of the deposition of scale on a surface in contact with a fluid susceptible to scale formation.

In some embodiments, said fluid in need of treatment may comprise a circulating fluid, such as, but not limited to, a circulating fluid utilized in, or is a component of, a mining process, or is in a system that is utilized in a mining process; a circulating fluid utilized in, or is a component of, a pulp, paper, and/or cardboard-related process, or is in a system that is utilized in a pulp, paper, and/or cardboard-related process; a circulating fluid is utilized in, or is a component of, an oil and gas exploration or production process, or is in a system that is utilized in an oil and gas exploration and production process; or a circulating fluid is utilized in, or is a component of, coal processing, or is in a system that is utilized in coal processing (e.g., coal slurry transport). In some embodiments, said fluid in need of treatment may comprise fluid used in any process or part of a process involved in such process as, but not limited to, a mining process, or a system that is utilized in a mining process; the processing of pulp, paper, and/or cardboard; an oil and gas exploration or production process, or an oil and gas exploration and production process; or coal processing, or is in a system that is utilized in coal processing (e.g., coal slurry transport). In some embodiments, a fluid in need of treatment may comprise produced water. In some embodiments, a fluid in need of treatment may comprise a fluid in which scale, e.g., sulfur-based scale such as iron sulfide, zinc sulfide, and/or lead sulfide, may form, particularly wherein scale formation is problematic for a process in which the fluid in need of treatment may be used or may be a part of. In some embodiments, said fluid in need of treatment may comprise hydrogen sulfide that may, due to the conditions in which said fluid in need of treatment is present, serve as a precursor for formation of a sulfur-based scale, such as iron sulfide and/or zinc sulfide and/or lead sulfide, wherein such scale may precipitate. In some embodiments, said fluid in need of treatment comprises boiler water, cooling water, seawater (e.g., in oil platform applications), brackish water, oilfield water (e.g., topside and/or downhole), coal processing water, or industrial treatment plant water. In some embodiments, said fluid in need of treatment may comprise oilfield water in need of treatment, i.e., in which scale, e.g., sulfur-based scale may form. In some embodiments, said fluid in need of treatment may comprise downhole water that is pumped underground (e.g., for enhanced oil recovery). In some embodiments, said fluid in need of treatment may comprise topside oilfield water. In some embodiments, said fluid in need of treatment may comprise any fluid resulting from any part of a process associated with enhanced oil recovery. In some embodiments, said fluid in need of treatment may comprise produced water. In some embodiments, said fluid in need of treatment may comprise water that is used in and/or results from any part of a gas recovery process. In some embodiments, said fluid in need of treatment may comprise water that is used in and/or results from any part of a process associated with a low cut gas well. In some embodiments, said fluid in need of treatment may comprise water that is used in and/or results from any part of a mining process. In some embodiments, said fluid in need of treatment may comprise water that is used in and/or results from any part of the processing of pulp, paper, and/or cardboard.

The compositions and methods illustratively disclosed herein suitably may be practiced in the absence of any element which is not specifically disclosed herein and/or any element specifically disclosed herein.

### EXAMPLES

### Example 1: Treatment of Sulfur-Based Scale

In this example, solutions in which scale (in the form of iron sulfide) was able to form were prepared, and experiments which evaluated the performance of various different doses of polymer-based scale modifiers were performed. Scale Modifier A and Scale Modifier B comprised homopolymers of DADMAC, wherein Scale Modifier A had a molecular weight of about 300,000 Da, and Scale Modifier B had a molecular weight of 300,000 Da. Scale Modifier C comprised a polymer comprising acrylamide and acrylic acid monomers. Scale Modifier D comprised a homopolymer of non-ionic acrylamide monomers.

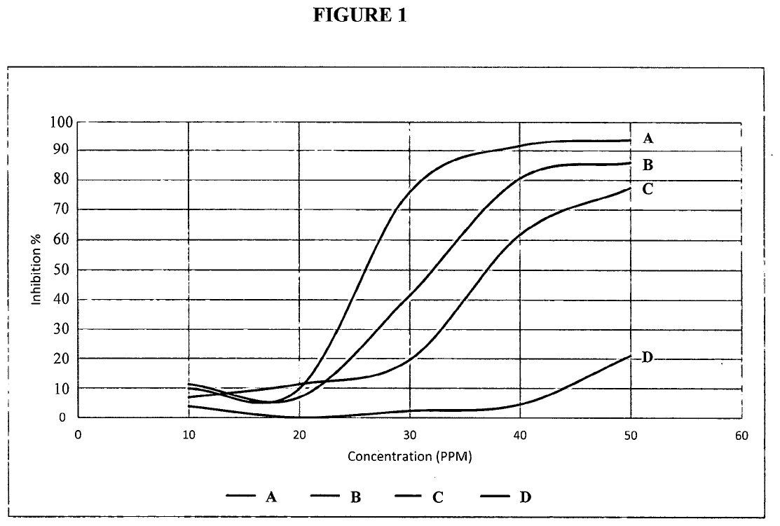

Referring now to FIG. 1, various different amounts of Scale Modifiers A-D were evaluated for their effects on iron sulfide scale formation in separate experimental runs. Doses of 10 ppm, 20 ppm, 30 ppm, 40 ppm, and 50 ppm of each of Scale Modifiers A-D were evaluated in separate trial runs.

The data of FIG. 1 demonstrated that the DADMAC-based scale modifiers were able to inhibit iron sulfide scale formation at various different dosages, and further that the DADMAC-based scale modifiers outperformed the acrylamide-polymer-based scale modifiers. It was observed that the maximum inhibition of iron sulfide scale formation occurred at a dosage of 50 ppm of Scale Modifier A, as the percent inhibition was greater than 95%. Similarly, Scale Modifier B was able to inhibit formation of iron sulfide scale, demonstrating a greater than 85% inhibition of scale formation at a dosage of 50 ppm.

### Example 2: Treatment of Sulfur-Based Scale

In this example, solutions in which sulfur-based scale, in the form of iron sulfide, were prepared, and experiments which evaluated the performance of various doses of polymer-based scale modifiers were performed. Scale Modifier A and Scale Modifier B were the same as above in Example 1, i.e., homopolymers of DADMAC of the molecular weights recited in Example 1. Scale Modifier E contained a homopolymer of DADMAC and had a molecular weight of about 200,000 Da. Scale Modifier F contained a homopolymer of DADMAC and had a molecular weight of about 200,000 Da.

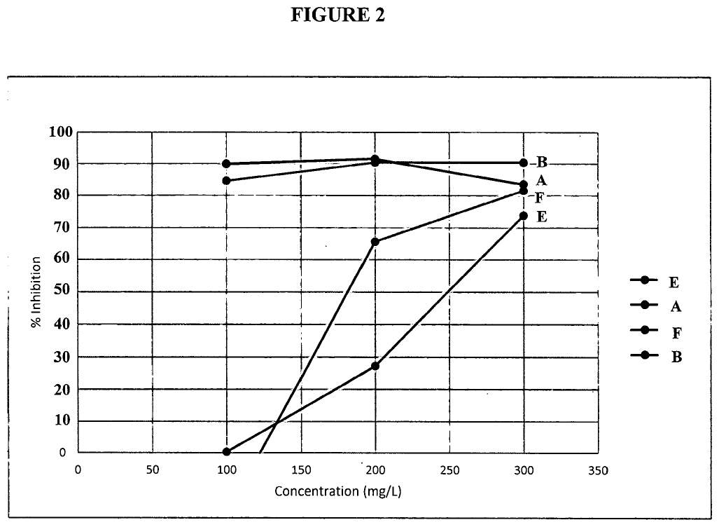

Referring now to FIG. 2, various different amounts of Scale Modifiers A, B, E, and F were evaluated for their effects on iron sulfide scale formation in separate experimental runs. Doses of 100 ppm, 200 ppm, and 300 ppm of each of the Scale Modifiers were evaluated in separate trial runs.

The data of FIG. 2 demonstrated that the DADMAC-based scale modifiers were able to inhibit iron sulfide scale formation at various different dosages. It was observed that the maximum inhibition of iron sulfide scale formation occurred at dosages of 100 ppm and 200 ppm of Scale Modifier A, and at a dosages of 200 ppm and 300 ppm of Scale Modifier B. Said dosages of Scale Modifier A and Scale Modifier B demonstrated at least 90% inhibition of iron sulfide formation. A 100 ppm dose of Scale Modifier A demonstrated an 85-90% inhibition of iron sulfide formation.

In the preceding procedures, various steps have been described. It will, however, be evident that various modifications and changes may be made thereto, and additional procedures may be implemented, without departing from the broader scope of the procedures as set forth in the claims that follow.

1. A method for reducing, inhibiting or stabilizing the formation of, or the amount of scale in a fluid, and/or reducing, inhibiting or stabilizing the deposition of scale on a surface in contact with said fluid, wherein said method comprises adding or introducing an amount of one or more scale modifiers to a fluid in need of treatment which is effective to reduce, inhibit or stabilize the formation or amount of scale in said fluid, and/or the deposition of scale on a surface in contact therewith wherein said one or more scale modifiers comprise one or more cationic polymers.

2. The method of claim 1, wherein:
i. said one or more cationic polymers comprise one or more diallyldimethylammonium chloride (DADMAC) monomers;
ii. said scale comprises one or more insoluble salts;
iii. said one or more scale modifiers comprise a polymer of one or more cationic monomers;
iv. said one or more scale modifiers comprise a homopolymer of cationic monomers;
v. said one or more scale modifiers comprise a homopolymer of DADMAC;
vi. said fluid in need of treatment is in an environment and/or comprises constituents which may result in the formation of sulfur-based scale, e.g., said fluid comprises hydrogen sulfide and one or more metals;
vii. said fluid in need of treatment comprises sulfur-based scale;
viii. said scale is caused in whole or part by bacteria such as sulfate-reducing bacteria;
ix. said scale is caused in whole or part by hydrogen sulfide which results from the decomposition of sulfur containing minerals, e.g., iron, lead and/or zinc;
x. said scale comprises any one or more of the following constituents: iron sulfide, zinc sulfide, lead sulfide, barium sulfate, strontium sulfate, and calcium sulfate;
xi. said scale comprises iron sulfide;
xii. said fluid in need of treatment comprises a fluid resulting from any part of a process or processes related to oil or gas production, extraction, and/or recovery;
xiii. said fluid in need of treatment comprises a circulating fluid, optionally wherein said circulating fluid comprises any one or more of the following: a circulating fluid utilized in, or a component of, a mining process, or in a system that is utilized in a mining process; a circulating fluid utilized in, or is a component of, a pulp, paper, and/or cardboard-related process, or is in a system that is utilized in a pulp, paper, and/or cardboard-related process; a circulating fluid utilized in, or a component of a reverse osmosis process; a circulating fluid utilized in, or a component of a geothermal application or method; a circulating fluid utilized in, or a component of, an oil and gas exploration or production process, or in a system that is utilized in an oil and gas exploration and production process; a circulating fluid utilized in, or a component of, coal processing, or a system that is utilized in coal processing (e.g., coal slurry transport);
xiv. said fluid comprises one used during processing of pulp, paper or cardboard;
xv. said fluid in need of treatment comprises produced water;
xvi. said fluid in need of treatment comprises hydrogen sulfide and further comprises one or more metals, e.g., iron, zinc, and/or lead, which may precipitate as a sulfur-based scale;
xvii. treatment of said fluid with said one or more scale modifiers results in a 5% reduction or less, a 5% reduction or more, a 10% reduction or more, a 15% reduction or more, a 20% reduction or more, a 25% reduction or more, a 30% reduction or more, a 35% reduction or more, a 40% reduction or more, a 45% reduction or more, a 50% reduction or more, a 55% reduction or more, a 60% reduction or more, a 65% reduction or more, a 70% reduction or more, a 75% reduction or more, an 80% reduction or more, an 85% reduction or more, a 90% reduction or more, a 91% reduction or more, a 92% reduction or more, a 93% reduction or more, a 94% reduction or more, a 95% reduction or more, a 96% reduction or more, a 97% reduction or more, a 98% reduction or more, or a 99% reduction or more of scale formation as compared to a method which did not comprise the use of said one or more scale modifiers;
xviii. said method further includes the addition of at least one biocide, e.g., one that kills or inhibits the proliferation of sulfate-reducing bacteria;
xix. said method comprises adding or introducing 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, or 500 ppm or more of said one or more scale modifiers;
xx. said method comprises adding or introducing an amount of said one or more scale modifiers which is an amount necessary to achieve a desired effect;
xxi. said one or more scale modifiers are provided in liquid form, such as an aqueous solution;
xxii. said one or more scale modifiers are provided in dry form and/or as a powder;
xxiii. said one or more scale modifiers are water-soluble;
xxiv. the molecular weight of said one or more scale modifiers is from about 10,000 to about 2,000,000 Daltons, optionally from about 200,000 to about 400,000 Da;
xxv. said addition or introduction of one or more scale modifiers is a continuous application;
xxvi. said addition or introduction of one or more scale modifiers is a direct injection;
xxvii. said addition or introduction of one or more scale modifiers is effected intermittently;
xxviii. the treatment occurs at atmospheric temperature;
xxix. the treatment occurs at 30° C. or less, 30° C. or more, 35° C. or more, 40° C. or more, 45° C. or more, 50° C. or more, 55° C. or more, 60° C. or more, 65° C. or more, 70° C. or more, 75° C. or more, 80° C. or more, 85° C. or more, 90° C. or more, 95° C. or more, or 100° C. or more, 125° C. or more, or 150° C. or more;
xxx. thermal treatment of the one or more scale modifiers does not affect the results achieved when using said one or more thermally treated scale modifiers as compared to untreated versions of the one or more scale modifiers;
xxxi. the pH at which treatment occurs is the pH of a fluid in need of treatment;
xxxii. said fluid comprises a fluid used in an aqueous system, optionally wherein said aqueous system is boiler water, cooling water, seawater (e.g., in oil platform applications), brackish water, oilfield water (e.g., topside and/or downhole), coal processing water, or industrial treatment plant water;
xxxiii. said fluid in need of treatment comprises oilfield water in need of treatment;
xxxiv. said fluid in need of treatment comprises oilfield water in need of treatment optionally wherein said oilfield water comprises downhole water that is pumped underground (e.g., for enhanced oil recovery);
xxxv. said fluid in need of treatment comprises oilfield water in need of treatment optionally wherein said oilfield water comprises topside oilfield water;
xxxvi. said fluid in need of treatment comprises any fluid resulting from any part of a process associated with enhanced oil recovery;
xxxvii. said fluid in need of treatment comprises water that is used in and/or results from any part of a gas recovery process;
xxxviii. said fluid in need of treatment comprises water that is used in and/or results from oil and/or gas recovery from a sour well;
xxxix. said fluid in need of treatment comprises water that is used in and/or results from any part of a process associated with a low cut gas well;
xl. said fluid in need of treatment comprises water that is used in and/or results from any part of a mining process;
xli. said fluid in need of treatment comprises water that is used in and/or results from any part of reverse osmosis;
xlii. said fluid in need of treatment comprises water that is used in and/or results from any part of a geothermal process or application;
xliii. said one or more scale modifiers are removed from treated process water after a desired period of time and/or a desired result has been achieved, such as by adding one or more oxidizing agents;
xliv. said method further comprises the addition of one or more corrosion inhibitors, optionally wherein said one or more corrosion inhibitors include imidazolines, fatty amines, benzotriazole, quinoline, rosin amine, sodium phosphate, silicate, and chromate;
xlv. the treatment prevents and/or reduces the plugging of production lines, filters, pumps, and/or screens that are used in conjunction with said fluid in need of treatment;
xlvi. the treatment prevents and/or reduces plugging of a fluid conduit disposed in an injection wellbore;
xlvii. the treatment prevents and/or reduces plugging of a subterranean formation;
xlviii. the treatment prevents and/or reduces plugging of a production well and/or components associated with a production well;
xlix. said fluid in need of treatment is used in conjunction with topside equipment;
l. said fluid in need of treatment comprises conditions suitable for the formation of sulfur-based scale, e.g., said fluid comprises hydrogen sulfide and one or more metals, and wherein said treatment does not generate any or does not generate as much hydrogen sulfide gas as compared to methods of treatment that do not comprise the use of one or more scale modifiers; and/or
li. a combination of any two or more of (i)-(l).

3. The method of claim 2, embodiment (xvii), wherein:
i. said scale comprises sulfur-based scale;
ii. said scale comprises sulfur-based scale and said sulfur-based scale is caused in whole or part by sulfate-reducing bacteria;
iii. said scale comprises sulfur-based scale and said sulfur-based scale is caused in whole or part by hydrogen sulfide resulting from the decomposition of sulfur containing minerals, e.g., iron, lead and/or zinc;
iv. said scale comprises sulfur-based scale and said sulfur-based scale comprises any one or more of the following constituents: iron sulfide, zinc sulfide, lead sulfide, barium sulfate, strontium sulfate, and calcium sulfate;
v. said scale comprises iron sulfide; and/or
vi. a combination of any two or more of (i)-(v).

4. The method of claim 2, embodiment (xviii), wherein:
i. the combined usage of said at least one biocide and said one or more scale modifiers which comprise one or more cationic polymers has an additive or synergistic effect on the reduction, inhibition or stabilization of the formation of, or the amount of scale in the treated fluid, and/or on the reduction, inhibition or stabilization of the deposition of scale on a surface in contact with said fluid;
ii. said at least one biocide comprises at least one oxidizing biocide, optionally wherein said oxidizing biocide is any one or more of the following: an oxidant selected from chlorine, alkali and alkaline earth hypochlorite salts, hypochlorous acid, chlorinated isocyanurates, bromine, alkali and alkaline earth hypobromite salts, hypobromous acid, bromine chloride, chlorine dioxide, ozone, hydrogen peroxide, peroxy compounds, such as peracetic acid, performic acid, percarbonate or persulfate salts, halogenated hydantoins, e.g., monohalodimethylhydantoins such as monochlorodimethylhydantoin, or dihalodimethylhydantoins such as chlorobromodimethylhydantoin, monochloramines, monobromamines, dihaloamines, trihaloamines, or a combination thereof; optionally combined with substituted an N-hydrogen compound, such as ammonium salts, ammonia, urea, hydantoin, isothiazoline-1,1-dioxide, ethanolamine, pyrrolidone, 2-pyrrolidone, ethylene urea, N-methylolurea, N-methylurea, acetylurea, pyrrole, indole, formamide, benzamide, acetamide, imidazoline, or morpholine; and monochloramine (MCA), chlorine dioxide, performic acid (PFA), peracetic acid, alkali and alkaline earth hypochlorite salts, and N-hydrogen compounds combined with an oxidant;
iii. said at least one biocide comprises at least one non-oxidizing biocide, optionally wherein said non-oxidizing biocide is any one or more of the following: glutaraldehyde, 2,2-dibromo-3-nitrilopropionamide (DBNPA), 2-bromo-2-nitropropane-1,3-diol (Bronopol), quaternary ammonium compounds, carbamates, 5-chloro-2-methyl-4-isothiazolin-3-one (CM IT), 2-methyl-4-isothiazolin-3-one (MIT), 1,2-dibromo-2,4-dicyanobutane, bis(trichloromethyl)sulfone, 2-bromo-2-nitrostyrene, 4,5-dichloro-1,2-dithiol-3-one, 2-n-octyl-4-isothiazolin-3-one, 1,2-benzisothiazolin-3-one, ortho-phthaldehyde, quaternary ammonium compounds (=“quats”), such as n-alkyl dimethyl benzyl ammonium chloride, didecyl dimethyl ammonium chloride (DDAC) or alkenyl dimethylethyl ammonium chloride, guanidines, biguanidines, pyrithiones, 3-iodopropynyl-N-butylcarbamate, phosphonium salts, such as tetrakis hydroxymethyl phosphonium sulfate (THPS), dazomet, 2-(thiocyanomethylthio) benzothiazole, methylene bisthiocyanate (MBT), and a combination thereof; and/or
iv. a combination of any two or more of (i)-(iii).

5. The method of claim 2, embodiment xlix, wherein:
i. said treatment prevents, reduces, and/or inhibits formation of an emulsified oil and water layer in said equipment, such as a layer that may result from formation of sulfur-based scale;
ii. said treatment prevents, reduces, and/or inhibits formation of sulfur-based scale in said fluid in need of treatment and/or deposition of sulfur-based scale onto said equipment; and/or
iii. a combination of (i) and (ii).

6. A composition suitable for use in the treatment of scale, wherein said composition comprises (i) an effective amount of one or more scale modifiers, wherein said one or more scale modifiers comprise one or more cationic polymers and (ii) optionally a fluid in need of treatment.

7. The composition of claim 6, wherein:
i. said composition further comprises at least one biocide, e.g., one that kills or inhibits the proliferation of sulfate-reducing bacteria;
ii. said one or more scale modifiers comprise a homopolymer of cationic monomers;
iii. said one or more scale modifiers comprise a homopolymer of DADMAC;
iv. said fluid comprises a circulating fluid;
v. said fluid comprises one used during processing of pulp, paper or cardboard;
vi. said circulating fluid comprises a circulating fluid utilized in, or is a component of, a mining process, or is in a system that is utilized in a mining process; a circulating fluid utilized in, or is a component of, a pulp, paper, and/or cardboard-related process, or is in a system that is utilized in a pulp, paper, and/or cardboard-related process; a circulating fluid utilized in, or a component of a reverse osmosis process; a circulating fluid utilized in, or a component of a geothermal application or method; a circulating fluid is utilized in, or is a component of, an oil and gas exploration or production process, or is in a system that is utilized in an oil and gas exploration and production process; or a circulating fluid is utilized in, or is a component of, coal processing, or is in a system that is utilized in coal processing (e.g., coal slurry transport);
vii. said fluid comprises fluid used in any process or part of a process involved in such process as, but not limited to, a mining process, or a system that is utilized in a mining process; a pulp, paper, and/or cardboard-related process, or a system that is utilized in a pulp, paper, and/or cardboard-related process; a reverse osmosis process, or a system that is utilized in reverse osmosis; a geothermal application or process, or a system that is utilized in a geothermal application or process; an oil and gas exploration or production process, or an oil and gas exploration and production process; or coal processing, or is in a system that is utilized in coal processing (e.g., coal slurry transport);
viii. said fluid in need of treatment comprises conditions suitable for the formation of sulfur-based scale, e.g., said fluid comprises hydrogen sulfide and one or more metals;
ix. said fluid in need of treatment comprises sulfur-based scale;
x. said fluid in need of treatment comprises any one or more of the following: iron sulfide, zinc sulfide, or lead sulfide;
xi. said fluid in need of treatment comprises iron sulfide;
xii. said fluid in need of treatment comprises boiler water, cooling water, seawater (e.g., in oil platform applications), brackish water, oilfield water (e.g., topside and/or downhole), coal processing water, or industrial treatment plant water;
xiii. said fluid in need of treatment comprises oilfield water in need of treatment;
xiv. said fluid in need of treatment comprises oilfield water in need of treatment and said oilfield water comprises downhole water that is pumped underground (e.g., for enhanced oil recovery);
xv. said fluid in need of treatment comprises oilfield water in need of treatment and said oilfield water comprises topside oilfield water;
xvi. said fluid in need of treatment comprises any fluid resulting from any part of a process associated with enhanced oil recovery;
xvii. said fluid in need of treatment comprises any fluid resulting from any part of a process associated with processing of pulp, paper and/or cardboard;
xviii. said fluid in need of treatment comprises produced water;
xix. said fluid in need of treatment comprises water that is used in and/or results from any part of a gas recovery process;
xx. said fluid in need of treatment comprises water that is used in and/or results from any part of reverse osmosis;
xxi. said fluid in need of treatment comprises water that is used in and/or results from any part of a geothermal process or application;
xxii. said fluid in need of treatment comprises a fluid associated with a sour well;
xxiii. said fluid in need of treatment comprises water that is used in and/or results from any part of a mining process;
xxiv. said fluid in need of treatment comprises a fluid used in conjunction with topside equipment;
xxv. further comprise one or more corrosion inhibitors, optionally wherein said one or more corrosion inhibitors include imidazolines, fatty amines, benzotriazole, quinoline, rosin amine, sodium phosphate, silicate, and chromate and/or
xxvi. a combination of any two or more of (i)-(xxv).

8. The composition of claim 7, embodiment (i), wherein:
i. the combination of said at least one biocide and said one or more scale modifier which comprises one or more cationic polymers has an additive or synergistic effect on the reduction, inhibition or stabilization of the formation of, or the amount of scale in a fluid susceptible to scale formation, and/or on the reduction, inhibition or stabilization of the deposition of scale on a surface in contact with a fluid susceptible to scale formation;
ii. said at least one biocide comprises at least one oxidizing biocide, optionally wherein said oxidizing biocide is any one or more of the following: an oxidant selected from chlorine, alkali and alkaline earth hypochlorite salts, hypochlorous acid, chlorinated isocyanurates, bromine, alkali and alkaline earth hypobromite salts, hypobromous acid, bromine chloride, chlorine dioxide, ozone, hydrogen peroxide, peroxy compounds, such as peracetic acid, performic acid, percarbonate or persulfate salts, halogenated hydantoins, e.g., monohalodimethylhydantoins such as monochlorodimethylhydantoin, or dihalodimethylhydantoins such as chlorobromodimethylhydantoin, monochloramines, monobromamines, dihaloamines, trihaloamines, or a combination thereof; optionally combined with substituted an N-hydrogen compound, such as ammonium salts, ammonia, urea, hydantoin, isothiazoline-1,1-dioxide, ethanolamine, pyrrolidone, 2-pyrrolidone, ethylene urea, N-methylolurea, N-methylurea, acetylurea, pyrrole, indole, formamide, benzamide, acetamide, imidazoline, or morpholine; and monochloramine (MCA), chlorine dioxide, performic acid (PFA), peracetic acid, alkali and alkaline earth hypochlorite salts, and N-hydrogen compounds combined with an oxidant;
iii. said at least one biocide comprises at least one non-oxidizing biocide, optionally wherein said non-oxidizing biocide is any one or more of the following: glutaraldehyde, 2,2-dibromo-3-nitrilopropionamide (DBNPA), 2-bromo-2-nitropropane-1,3-diol (Bronopol), quaternary ammonium compounds, carbamates, 5-chloro-2-methyl-4-isothiazolin-3-one (CM IT), 2-methyl-4-isothiazolin-3-one (MIT), 1,2-dibromo-2,4-dicyanobutane, bis(trichloromethyl)sulfone, 2-bromo-2-nitrostyrene, 4,5-dichloro-1,2-dithiol-3-one, 2-n-octyl-4-isothiazolin-3-one, 1,2-benzisothiazolin-3-one, ortho-phthaldehyde, quaternary ammonium compounds (=“quats”), such as n-alkyl dimethyl benzyl ammonium chloride, didecyl dimethyl ammonium chloride (DDAC) or alkenyl dimethylethyl ammonium chloride, guanidines, biguanidines, pyrithiones, 3-iodopropynyl-N-butylcarbamate, phosphonium salts, such as tetrakis hydroxymethyl phosphonium sulfate (THPS), dazomet, 2-(thiocyanomethylthio) benzothiazole, methylene bisthiocyanate (MBT), and a combination thereof; and/or
iv. a combination of any two or more of (i)-(iii).
